(19) United States
(12) Patent Application Publication
(10) Pub. No.: US 2024/0154674 A1
(43) Pub. Date: May 9, 2024

(54) ALLOCATING CHANNEL STATE INFORMATION (CSI) PROCESSING UNIT (CPU) FOR USER EQUIPMENT (UE)-INITIATED CSI FEEDBACK

(71) Applicant: QUALCOMM Incorporated, San Diego, CA (US)

(72) Inventors: Kangqi LIU, San Diego, CA (US); Chenxi HAO, Beijing (CN); Yu ZHANG, San Diego, CA (US); Fang YUAN, Beijing (CN); Liangming WU, Beijing (CN); Chao WEI, Beijing (CN); Min HUANG, Beijing (CN); Qiaoyu LI, Beijing (CN); Hao XU, Beijing (CN)

(21) Appl. No.: 18/549,413

(22) PCT Filed: Apr. 7, 2022
(86) PCT No.: PCT/CN2022/085480

§ 371 Date: Sep. 7, 2023

(30) Foreign Application Priority Data
Apr. 7, 2021 (WO) PCT/CN2021/085770

(51) Int. Cl. H04B 7/06; H04L 5/00; H04W 72/1268; H04W 76/20

(52) U.S. Cl. CPC H04B 7/0626; H04L 5/0051; H04W 72/1268; H04W 76/20

(57) ABSTRACT

Certain aspects of the present disclosure provide techniques for allocating channel state information (CSI) processing unit (CPU) for user equipment (UE) initiated CSI. For example, the UE may receive an indication from a network entity (e.g., a base station or gNB) configuring the UE with a number of one or more CPUs allowed to be occupied for UE-initiated CSI feedback. The UE uses the at least one of the CPUs to calculate UE-initiated CSI feedback. The UE transmits at least one report including the UE-initiated CSI feedback if one or more conditions are met, such as when a mismatch between a CSI metric for a scheduled physical downlink shared channel (PDSCH) and a CSI metric calculated as part of the UE-initiated CSI feedback is equal to or exceeding a threshold value.

### CROSS REFERENCE TO RELATED APPLICATIONS

This application claims benefits of and priority to PCT International Application No. PCT/CN2021/085770, filed on Apr. 7, 2021, which is assigned to the assignee hereof and herein incorporated by reference in the entirety as if fully set forth below and for all applicable purposes.

### BACKGROUND

### Field of the Disclosure

Aspects of the present disclosure relate to wireless communications, and more particularly, to channel state information (CSI) feedback.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims, which follow, some features will now be discussed briefly. After considering this discussion, and particularly after reading the section entitled “Detailed Description” one will understand how the features of this disclosure provide advantages that include improved communications between access-points and stations in a wireless network.

Certain aspects of the subject matter described in this disclosure can be implemented in a method for wireless communication by a user equipment (UE). The method generally includes receiving an indication from a network entity configuring the UE with a number of one or more channel state information (CSI) processing units (CPUs) allowed to be occupied for UE-initiated CSI feedback; and transmitting at least one report including the UE-initiated CSI feedback if one or more conditions are met.

Certain aspects of the subject matter described in this disclosure can be implemented in a method for wireless communication by a network entity. The method generally includes transmitting an indication to configure a user equipment (UE) with a number of one or more channel state information (CSI) processing units (CPUs) allowed to be occupied for UE-initiated CSI feedback; monitoring for UE-initiated CSI feedback calculated by at least one of the CPUs; and receiving at least one report including the UE-initiated CSI feedback when one or more conditions are met.

Certain aspects of the subject matter described in this disclosure can be implemented in an apparatus for wireless communication by a user equipment (UE). The UE includes a memory comprising executable instructions; and one or more processors configured to execute the executable instructions and cause the apparatus to: receive an indication from a network entity configuring the UE with a number of one or more channel state information (CSI) processing units (CPUs) allowed to be occupied for UE-initiated CSI feedback; and transmit at least one report including the UE-initiated CSI feedback if one or more conditions are met.

Certain aspects of the subject matter described in this disclosure can be implemented in an apparatus for wireless communication by a user equipment (UE). The apparatus includes means for receiving an indication from a network entity configuring the UE with a number of one or more channel state information (CSI) processing units (CPUs) allowed to be occupied for UE-initiated CSI feedback. The apparatus further includes means for transmitting at least one report including the UE-initiated CSI feedback if one or more conditions are met.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for new radio (NR), in accordance with certain aspects of the present disclosure.

FIG. 4 is an example framework for a dynamic channel state information (CSI) report configuration.

FIG. 5A is an example CSI report triggered by gNB due to outdated CSI, in aspects associated with the present disclosure.

FIG. 5B is an example UE-initiated CSI report based on demodulation reference signal (DMRS), in aspects associated with the present disclosure.

FIG. 6A is an example UE-initiated CSI feedback based on CSI reference signal (CSI-RS), in accordance with certain aspects of the present disclosure.

FIG. 6B is an example UE-initiated CSI feedback based on DMRS or CSI-RS, in accordance with certain aspects of the present disclosure.

FIG. 7A is an example downlink (DL) grant CSI feedback based on CSI-RS, in accordance with certain aspects of the present disclosure.

FIG. 7B is an example DL-grant CSI feedback based on DMRS or physical downlink shared channel (PDSCH), in accordance with certain aspects of the present disclosure.

FIG. 8 is a flow diagram illustrating example operations for wireless communication by a UE, in accordance with certain aspects of the present disclosure.

FIG. 9 is a flow diagram illustrating example operations for wireless communication by a network entity, in accordance with certain aspects of the present disclosure.

FIG. 10 is an example timeline for CSI processing unit (CPU) occupancy when the channel measurement resource (CMR) type is CSI-RS, in accordance with certain aspects of the present disclosure.

FIG. 11 is an example timeline for CPU occupancy when the CMR type is DMRS or PDSCH, in accordance with certain aspects of the present disclosure.

FIG. 12 is an example timeline for CPU occupancy when the CMR type is CSI-RS and when at least one CPU is released for reuse, in accordance with certain aspects of the present disclosure.

FIG. 13 is an example timeline for CPU occupancy when the CMR type is DMRS or PDSCH and when at least one CPU is released for reuse, in accordance with certain aspects of the present disclosure.

FIG. 14 is an example timeline for CPU occupancy when the CMR type is CSI-RS and when the UE does not release the CPU until physical uplink control channel (PUCCH), in accordance with certain aspects of the present disclosure.

FIG. 15 is an example timeline for CPU occupancy when the CMR type is DMRS or PDSCH and when the UE does not release the CPU until PUCCH in accordance with certain aspects of the present disclosure.

FIG. 16 illustrates a communications device that may include various components configured to perform operations for the techniques disclosed herein in accordance with aspects of the present disclosure.

FIG. 17 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for allocating channel state information (CSI) processing unit (CPU) for user equipment (UE) initiated CSI. For example, the UE may receive an indication from a network entity (e.g., a base station or gNB) configuring the UE with a number of one or more CPUs allowed to be occupied for UE-initiated CSI feedback. The UE uses the at least one of the CPUs to calculate UE-initiated CSI feedback. The UE transmits at least one report including the UE-initiated CSI feedback if one or more conditions are met, such as when a mismatch between a CSI metric for a scheduled physical downlink shared channel (PDSCH) and a CSI metric calculated as part of the UE-initiated CSI feedback is equal to or exceeding a threshold value.

In certain systems, such as new radio (NR) systems, a UE is configured with N non-zero power (NZP) channel state information (CSI) reference signal (CSI-RS) resources for channel measurement (CMRs). The UE is configured to select one resource out of the configured N resources. The UE is also configured with CSI-RS resources for interference measurement (CSI-IMRs). The resources for interference measurement are associated with the configured resources for channel measurement. This CSI framework allows dynamic channel/interference hypothesis, for example, in the case of transmission by a single transmission reception point (TRP) or multiple TRPs.

When aperiodic CSI (A-CSI) is triggered via uplink (UL) related downlink control information (DCI), CSI feedback is often not flexible or at least less flexible than CSI feedback related to downlink (DL) DCI. For example, more DCI formats (e.g., UL DCI 0-1, DL DCI 1-1, etc.) may be used to allow CSI to be transmitted on reserved UL: resource, not necessarily on dynamically scheduled PUSCH. In addition, CSI can be measured or calculated based on DMRS (e.g., may be more efficient than using CSI-RS for enabling a fast timeline). In some cases, UE-initiated CSI feedback is enabled to enhance rate-control for high-Doppler scenarios. However, the UE-initiated CSI feedback requires processing units (CPUs) allocated for calculation. The present disclosure provides techniques or schemes for allocating the CPUs.

The following description provides examples of allocating CPUs for UE-initiated CSIs in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

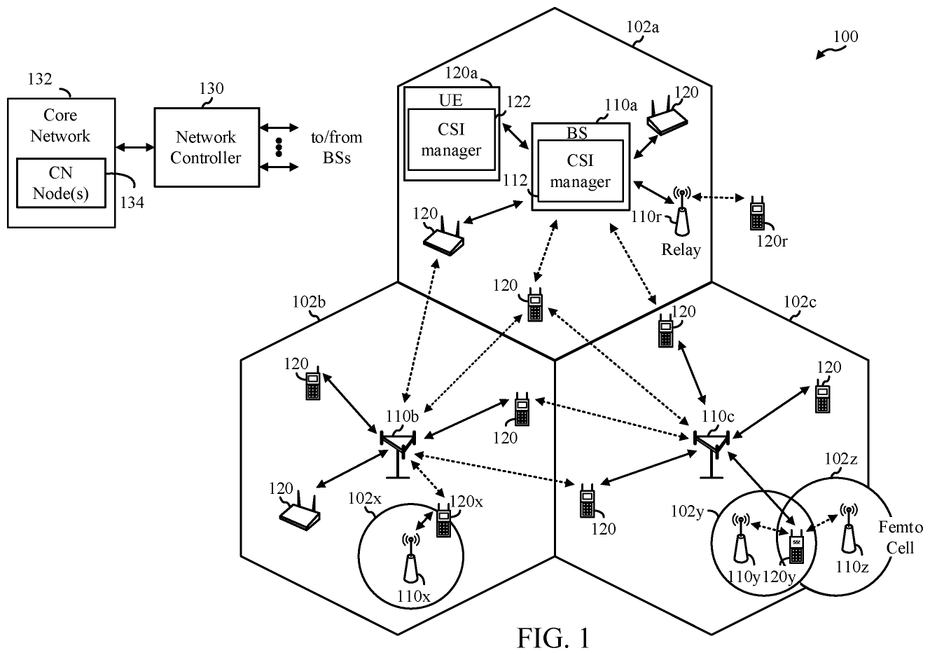

FIG. 1 illustrates an example wireless communication network 100 in which aspects of the present disclosure may be performed. For example, according to certain aspects, the BSs 110 and UEs 120 may be configured for allocating CPUs for UE-initiated CSIs. As shown in FIG. 1, the BS 110a includes a CSI manager 112. As shown in FIG. 1, the UE 120a includes a CSI manager 122. The CSI manager 112 and the CSI manager 122 may be configured to perform allocating CPUs for UE-initiated CSIs, in accordance with aspects of the present disclosure.

The wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell,” which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. A network controller 130 may couple to a set of BSs 110 and provide coordination and control for these BSs 110 (e.g., via a backhaul).

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

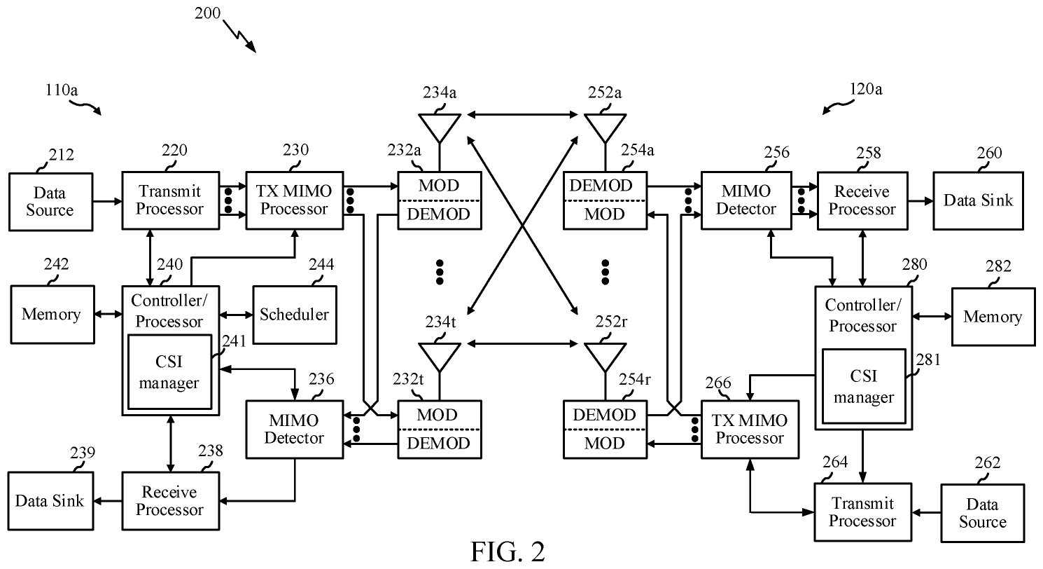

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (P S SCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a CSI manager 241 that may be configured for allocating CPUs for UE-initiated CSIs, according to aspects described herein. As shown in FIG. 2, the controller/processor 280 of the UE 120a has a CSI manager 281 that may be configured for allocating CPUs for UE-initiated CSIs, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

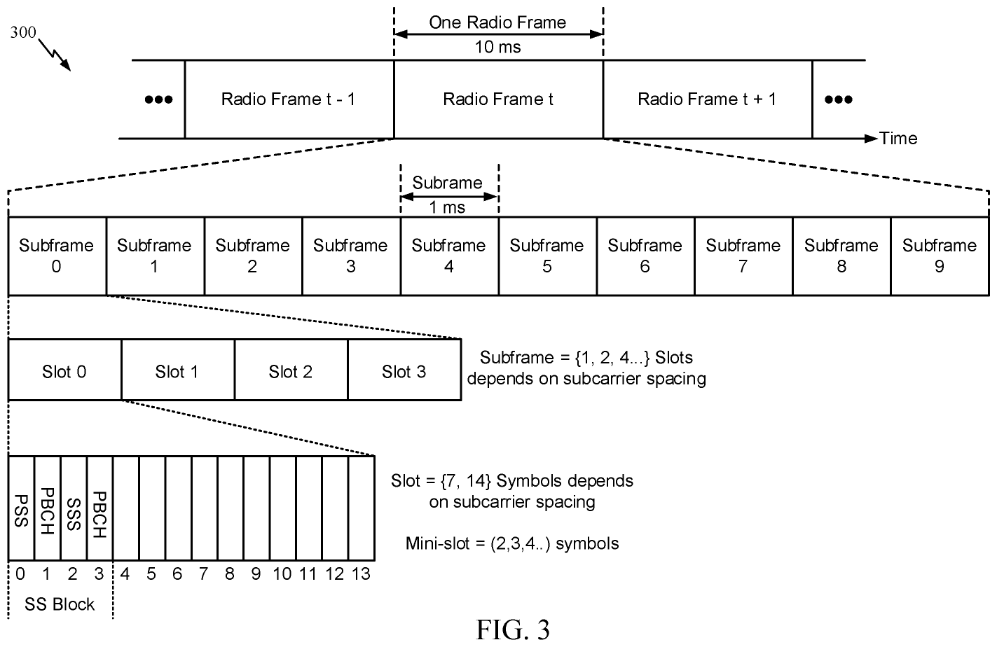

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7 or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

### Overview of Disaggregated Network Entity

In various aspects, a network entity or network node can be implemented as an aggregated base station, as a disaggregated base station, an integrated access and backhaul (IAB) node, a relay node, a sidelink node, to name a few examples.

A disaggregated base station architecture may include one or more central units (CUs) that can communicate directly with a core network via a backhaul link, or indirectly with the core network through one or more disaggregated base station units (such as a Near-Real Time (Near-RT) RAN Intelligent Controller (RIC) via an E2 link, or a Non-Real Time (Non-RT) RIC associated with a Service Management and Orchestration (SMO) Framework, or both). A CU may communicate with one or more distributed units (DUs) via respective midhaul links, such as an F1 interface. The DUs may communicate with one or more radio units (RUs) via respective fronthaul links. The RUs may communicate with respective UEs via one or more radio frequency (RF) access links. In some implementations, the UE may be simultaneously served by multiple RUs.

Each of the units, i.e., the CUs, the DUs, the RUs, as well as the Near-RT RICs, the Non-RT RICs and the SMO Framework, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU. The CU may be configured to handle user plane functionality (i.e., Central Unit-User Plane (CU-UP)), control plane functionality (i.e., Central Unit-Control Plane (CU-CP)), or a combination thereof. In some implementations, the CU can be logically split into one or more CU-UP units and one or more CU-CP units. The CU-UP unit can communicate bidirectionally with the CU-CP unit via an interface, such as the E1 interface when implemented in an O-RAN configuration. The CU can be implemented to communicate with the DU, as necessary, for network control and signaling.

The DU may correspond to a logical unit that includes one or more base station functions to control the operation of one or more RUs. In some aspects, the DU may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3 rd Generation Partnership Project (3GPP). In some aspects, the DU may further host one or more low PHY layers. Each layer (or module) can be implemented with an interface configured to communicate signals with other layers (and modules) hosted by the DU, or with the control functions hosted by the CU.

Lower-layer functionality can be implemented by one or more RUs. In some deployments, an RU, controlled by a DU, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) can be implemented to handle over the air (OTA) communication with one or more UEs. In some implementations, real-time and non-real-time aspects of control and user plane communication with the RU(s) can be controlled by the corresponding DU. In some scenarios, this configuration can enable the DU(s) and the CU to be implemented in a cloud-based RAN architecture, such as a vRAN architecture.

The SMO Framework may be configured to support RAN deployment and provisioning of non-virtualized and virtualized network elements. For non-virtualized network elements, the SMO Framework may be configured to support the deployment of dedicated physical resources for RAN coverage requirements which may be managed via an operations and maintenance interface (such as an O1 interface). For virtualized network elements, the SMO Framework may be configured to interact with a cloud computing platform (such as an open cloud (O-Cloud)) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework can communicate with a hardware aspect of a 4G RAN, such as an open eNB (O-eNB), via an O1 interface. Additionally, in some implementations, the SMO Framework can communicate directly with one or more RUs via an O1 interface. The SMO Framework also may include a Non-RT RIC configured to support functionality of the SMO Framework.

The Non-RT RIC may be configured to include a logical function that enables non-real-time control and optimization of RAN elements and resources, Artificial Intelligence/Machine Learning (AI/ML) workflows including model training and updates, or policy-based guidance of applications/features in the Near-RT RIC. The Non-RT RIC may be coupled to or communicate with (such as via an A1 interface) the Near-RT RIC. The Near-RT RIC may be configured to include a logical function that enables near-real-time control and optimization of RAN elements and resources via data collection and actions over an interface (such as via an E2 interface) connecting one or more CUs, one or more DUs, or both, as well as an 0-eNB, with the Near-RT RIC.

In some implementations, to generate AI/ML models to be deployed in the Near-RT RIC, the Non-RT RIC may receive parameters or external enrichment information from external servers. Such information may be utilized by the Near-RT RIC and may be received at the SMO Framework or the Non-RT RIC from non-network data sources or from network functions. In some examples, the Non-RT RIC or the Near-RT RIC may be configured to tune RAN behavior or performance. For example, the Non-RT RIC may monitor long-term trends and patterns for performance and employ AI/ML models to perform corrective actions through the SMO Framework (such as reconfiguration via O1) or via creation of RAN management policies (such as A1 policies). Example CSI

### Feedback Configuration

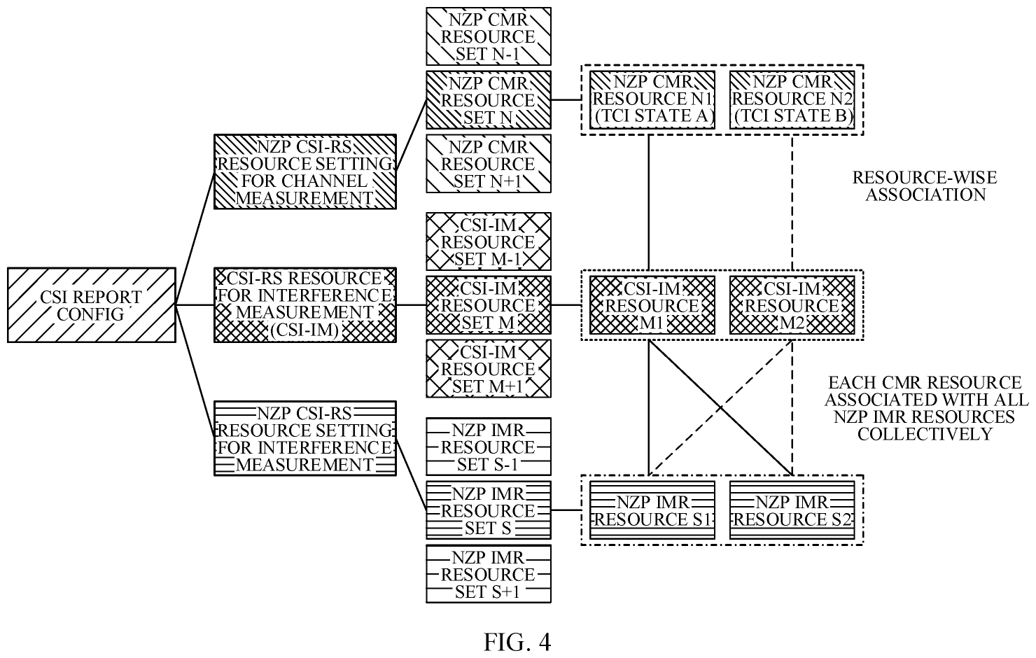

As discussed above, a UE may be configured with a CSI report configuration. FIG. 4 illustrates an example CSI report configuration. As shown in FIG. 4, the CSI report configuration may configure the UE with a CMR setting, a CMR setting and CSI-IM setting, or with a CMR setting, CSI-IM setting, and NZP-IMR setting. Each setting may be associated with multiple resource sets, each resource set including multiple resources.

In some examples, the number of resources in the CMR sets may be the same as the number of resources in the CSI-IM sets, but the number of resources in the NZP-IMR sets may be different. Each resource setting may have one active set at a given time. The active set may have up to N=8 resources, and the UE may be configured to select one resource out of N configured CMRs. The CMRs may be resource-wise associated with a CSI-IM resource and NZP-IMR set.

Each port of the NZP-IMRs may correspond to an interference layer. The NZP-IMRs and the CSI-IMs may share a Type-D QCL with the associated CMR. The UE may measure interference from the interference resources associated with the selected CMR. The UE may use the interference measurements to perform interference mitigation. The CSI report configuration supports CSI for one or more TRPs.

### Example Allocation of CPUs for UE-Initiated CSIs

Aspects of the present disclosure provide techniques for allocating CPUs for UE-initiated CSI reporting. A CPU generally refers to an amount of processing overhead used for processing CSI measurement and reporting and may be considered a UE capability (and reported as such). The CPU allocation scheme described may specify reservation and release of CPUs for UE-initiated CSI. For example, the UE may receive an indication from a network entity configuring the UE with a number of one or more CPUs allowed to be occupied for UE-initiated CSI feedback.

The UE-initiated CSI feedback may be calculated based on at least one of CSI-RS or DMRS. The UE may transmit at least one report including the UE-initiated CSI feedback if one or more conditions are met. In some cases, the one or more conditions may include a mismatch between a CSI metric for a scheduled PDSCH and a CSI metric calculated as part of the UE-initiated CSI feedback being equal to or exceeding a threshold value.

According to certain aspects, a network entity may configure a number of CPUs reserved for UE-initiated CSI calculation. The number of CPUs reserved for UE-initiated CSI calculation may be represented by the parameter O_{CPU}′, the total number of available CPUs may be represented by the parameter O_{CPU}, a maximum number of CPUs that can be used for UE initiated CSI may be represented by parameter O_{CPU,max}′. Thus, the number of CPUs reserved for normal (not UE-initiated) CSI calculation may be calculated as O_{CPU}−O_{CPU,max}′. The UE may use the configured number of CPUs reserved for calculating UE-initiated CSI. The reserved CPUs may be released for another reservation when certain conditions are met. For example, the UE may release the CPU after the last symbol of the configured PUSCH/PUCCH carrying the CSI report. When there is no UE-initiated CSI report, the network entity may assume that there is no mismatch. In this case, the number of occupied CPU reserved for UE-initiated CSI calculation is not transparent to the network entity.

In some cases, the UE may release the CPU when the mismatch value is less than the configured threshold (e.g., there may be little change relative to a previous report and the CPU may be released to allow for other CSI measurement/reporting). The UE may begin UE-initiated CSI calculation when there are unoccupied CPU reserved for UE-initiated CSI. The number of occupied CPUs reserved for UE-initiated CSI may be transparent to the network. The UE-initiated CSI report in UL resource is expected to be the updated one. The network may monitor UE-initiated CSI report in the UL resource when allowing UE-initiated CSI. In some cases, the UE may release the CPU at a time instance that occurs a number of symbols (e.g., m symbols) after starting to use the CPU to calculate UE-initiated CSI feedback.

According to certain aspects, the network may update the number of CPUs reserved for UE initiated CSI. For example, in such cases, the UE may be configured with an updated number of CPUs via DCI, MAC-CE, or radio resource control (RRC) signaling.

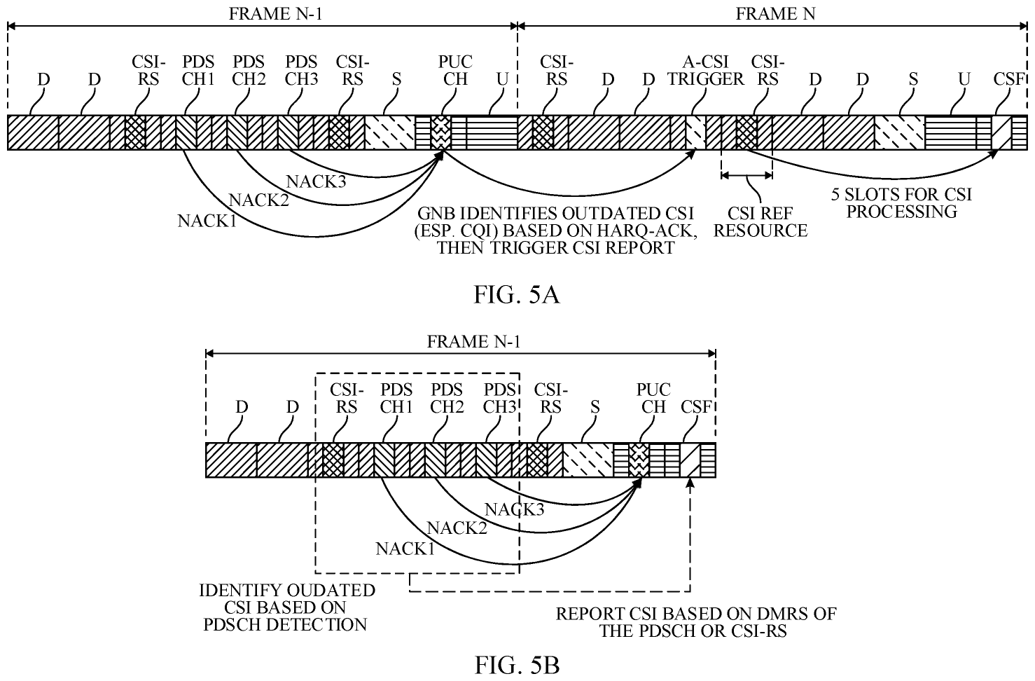

FIG. 5A is an example CSI report triggered by gNB due to outdated CSI, in accordance with aspects associated with the present disclosure. Conventionally, the gNB may control whether UE reports a CSI by sending a CSI request. The gNB may trigger new CSI reporting upon identifying an outdated CSI based on hybrid automatic repeat request (HARQ)-ACK. As shown, the UE may report (in a PUCCH) NACKs for PDSCHs (e.g., PDSCH1, PDSCH2, and PDSCH3), which may indicate outdated CSI (and that new CSI reporting may be beneficial). Based on the PUCCH indicating the NACKs, the gNB may trigger a CSI report via the A-CSI trigger. CSI processing may take another five slots from the CSI-RS on which the CSI is generated. After this time the CSI may be reported as channel state feedback (CSF). As shown, this procedure results in a large latency between the failed PDSCH and updated CSI.

As shown in FIG. 5B, a UE-initiated CSI reporting procedure may result in reduced latency relative to the gNB triggered CSI reporting shown in FIG. 5A. As shown, the UE may identify outdated CSI based on PDSCH detection and report CSI based on DMRS of the PDSCH or CSI-RS. By associating CSI with DL DCI (framework, measurement resource, report quantity), the UE may send CSI feedback to the gNB much sooner when compared to the gNB initiated CSI reporting of FIG. 5A.

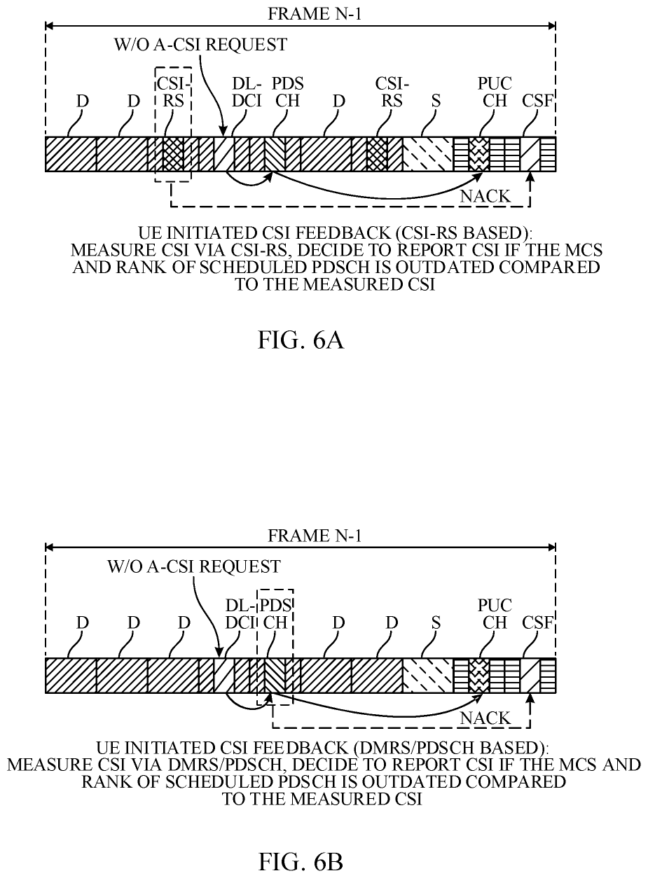

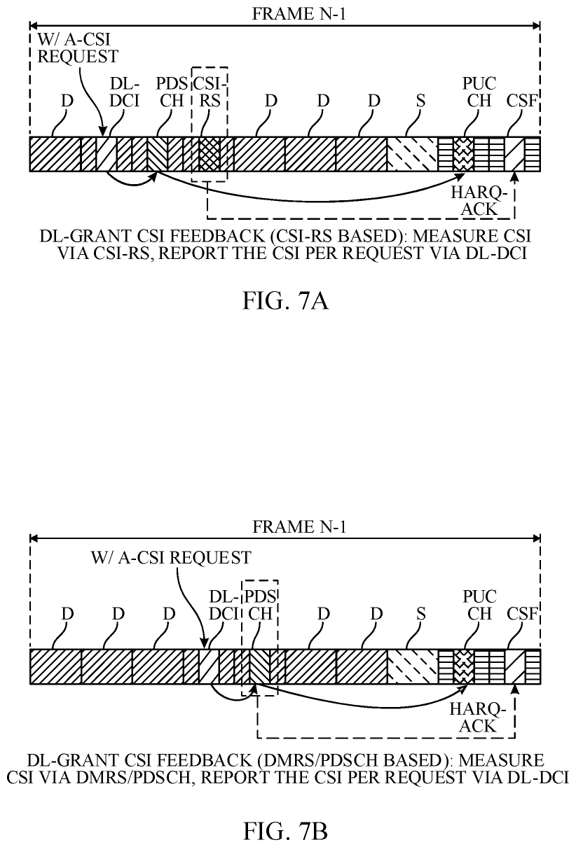

Examples of UE-initiated CSI feedback are shown in FIGS. 6A, 6B, 7A, and 7B and discussed below.

FIG. 6A is an example of UE-initiated CSI feedback based on a CSI reference signal (CSI-RS) without a gNB initiated A-CSI request, in accordance with certain aspects of the present disclosure. The UE may initiate CSI feedback by measuring CSI via CSI-RS. When the modulation and coding scheme (MCS) and/or rank of the scheduled PDSCH is outdated compared to the measured CSI (e.g., by at least a threshold mismatch amount), the UE transmits the UE-initiated CSI feedback to the gNB.

FIG. 6B is an example of UE-initiated CSI feedback based on DMRS or PDSCH without a gNB initiated A-CSI request, in accordance with certain aspects of the present disclosure. The UE may initiate CSI feedback by measuring CSI via DMRS or PDSCH. When the MCS and/or rank of the scheduled PDSCH is outdated compared to the measured CSI, the UE transmits the UE-initiated CSI feedback to the gNB. As shown, the examples in FIGS. 6A and 6B are applicable for cases without A-CSI request.

FIG. 7A is an example of downlink (DL) grant CSI feedback based on CSI-RS, in accordance with certain aspects of the present disclosure. The UE may initiate CSI feedback by measuring CSI via DMRS or CSI-RS in cases of downlink (DL) grant DCI with A-CSI request from the gNB. When the UE receives the A-CSI request via the DL-DCI and is triggered by the CSI-RS, the UE transmits the UE-initiated CSI feedback to the gNB.

FIG. 7B is an example of DL-grant CSI feedback based on DMRS or physical downlink shared channel (PDSCH), in accordance with certain aspects of the present disclosure. The UE may initiate CSI feedback by measuring CSI via DMRS or PDSCH in cases of downlink (DL) grant CSI with A-CSI request from the gNB. Based on DMRS or PDSCH and without CSI-RS, the UE, on receiving the A-CSI request via DL-DCI, transmits the UE-initiated CSI feedback to the gNB. As shown, the examples in FIGS. 7A and 7B are applicable for cases with the A-CSI request.

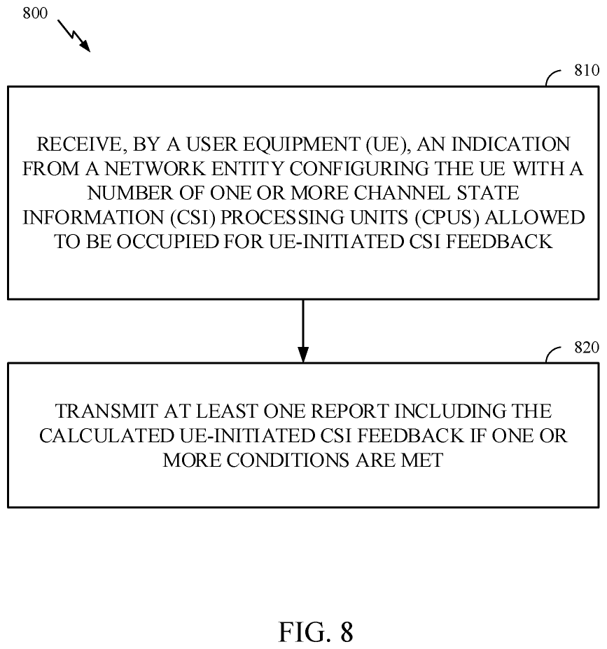

FIG. 8 is a flow diagram illustrating example operations 800 for wireless communication, in accordance with certain aspects of the present disclosure. The operations 800 may be performed, for example, by UE (e.g., such as a UE 120a in the wireless communication network 100). Operations 800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 800 may begin, at 810, by receiving an indication from a network entity configuring the UE with a number of one or more CPUs allowed to be occupied for UE-initiated CSI feedback. For example, the network entity may configure the UE to reserve a number of CPUs for processing UE-initiated CSI feedback.

At 820, the UE transmits at least one report including the UE-initiated CSI feedback if one or more conditions are met.

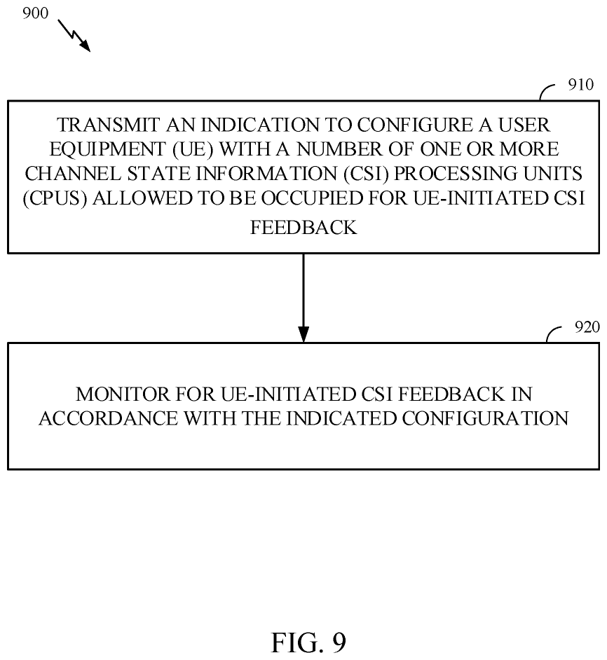

FIG. 9 is a flow diagram illustrating example operations 900 that may be considered complementary to operations 800 of FIG. 8. The operations 900 may be performed, for example, by a network entity (e.g., such as the BS 110a in the wireless communication network 100) receiving the UE-initiated CSI feedback. Operations 900 may be implemented as software components that are executed and run on one or more processors (e.g., controller/processor 240 of FIG. 2). Further, the transmission and reception of signals by the network entity in operations 900 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals.

The operations 900 may begin, at 910, by transmitting, to a UE, an indication to configure the UE with a number of one or more CPUs allowed to be occupied for UE-initiated feedback.

At 920, the network entity monitors for UE-initiated CSI feedback in accordance with the indicated configuration.

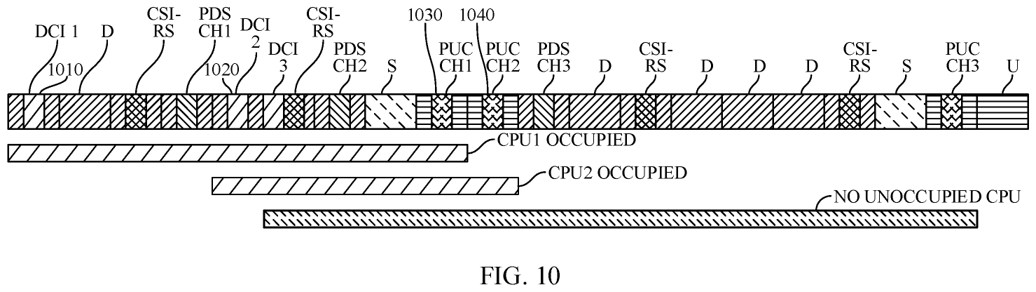

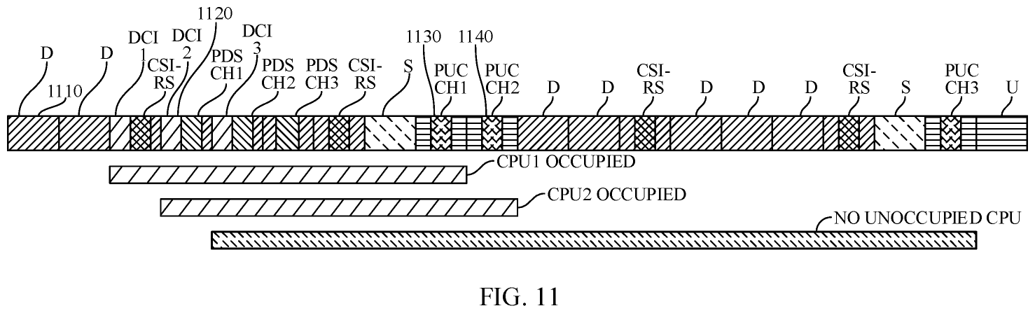

Operations 800 and 900 may be understood with reference to timelines for UE initiated CSI reporting shown in FIGS. 10 and 11.

In aspects, the UE may release CPUs used in calculating the UE-initiated CSI feedback after a last symbol of a physical uplink shared channel (PUSCH) or physical uplink control channel (PUCCH) carrying the UE-initiated CSI feedback. For example, the UE may release the CPU only after the last symbol of the configured PUSCH or PUCCH carrying the UE-initiated CSI feedback. When there is no UE-initiated CSI feedback, the network entity may not expect any mismatch has occurred.

FIG. 10 is an example timeline for CSI processing unit (CPU) occupancy when the channel measurement resource (CMR) type is CSI-RS. As shown, assuming that the number of CPUs reserved for UE-initiated CSI is 2, i.e., O_{CPU}′=2, CPU1 has been occupied starting DCI1 (slot 1010) through PUCCH1 (slot 1030), CPU2 has been occupied starting DCI2 (slot 1020) through PUCCH2 (slot 1040). “DCI1” denotes a first DCI received in order for the convenience of discussion herein. Similarly, “DCI2” denotes a second DCI received. Likewise, “PUCCH1” denotes a first PUCCH to be transmitted; and “PUCCH2” denotes a second PUCCH to be transmitted.

As CPU1 and CPU2 are not released after the last symbol of the PUCCH1 or PUCCH2, there is no CPU available for UE initiated CSI reporting based on DCI3. As such, the network entity will not expect any UE-initiated CSI reported in PUCCH3, where the network will not monitor UE-initiated CSI. If the UE is able to complete the UE-initiated CSI calculation in slot 1020 (corresponding to DCI2) and finds that the mismatch value is less than the configured threshold, the UE is unable to release the CPU to calculate the UE-initiated CSI based on DCI3. Thus, the network entity is able to know the reason if there is no UE-initiated CSI in PUCCH, for example, there is no unoccupied CPU or mismatch value is less than the configured threshold.

FIG. 11 is an example timeline for CPU occupancy when the CMR type is DMRS or PDSCH. As shown, assuming that the number of CPUs reserved for UE-initiated CSI is 2, i.e., O_{CPU}′=2, CPU1 has been occupied starting DCI1 (slot 1110) through PUCCH1 (slot 1130), CPU2 has been occupied starting DCI2 (slot 1120) through PUCCH2 (slot 1140). Similar to the situation in FIG. 10 (except for the different CMR type), since CPU1 and CPU2 are not released after the last symbol of the PUCCH1 or PUCCH2, there is no CPU available for UE initiated CSI reporting based on DCI3. The network entity will not expect any UE-initiated CSI reported in PUCCH3, where the network will not monitor UE-initiated CSI. If the UE is able to complete the UE-initiated CSI calculation and finds that the mismatch value is less than the configured threshold, the UE is unable to release the CPU to calculate the UE-initiated CSI based on DCI3.

In some cases, the number of occupied CPU reserved for UE-initiated CSI may not be transparent to the network. For example, the UE may release CPUs used in calculating the UE-initiated CSI feedback without reporting the calculated UE-initiated CSI feedback if a mismatch between the CSI metric for a scheduled PDSCH and the CSI metric calculated as part of the UE-initiated CSI feedback is less than the threshold value. The CSI metric for the scheduled PDSCH may include at least one of a modulation and coding scheme (MCS) or rank.

In aspects, the UE may receive signaling from the network entity indicating the UE can release CPUs used in calculating the UE-initiated CSI feedback if the mismatch between the CSI metric for the scheduled PDSCH and the CSI metric calculated as part of the UE-initiated CSI feedback is less than the threshold value.

In aspects, the network entity may transmit signaling to the UE indicating at least one of the threshold value or the type of CSI metric.

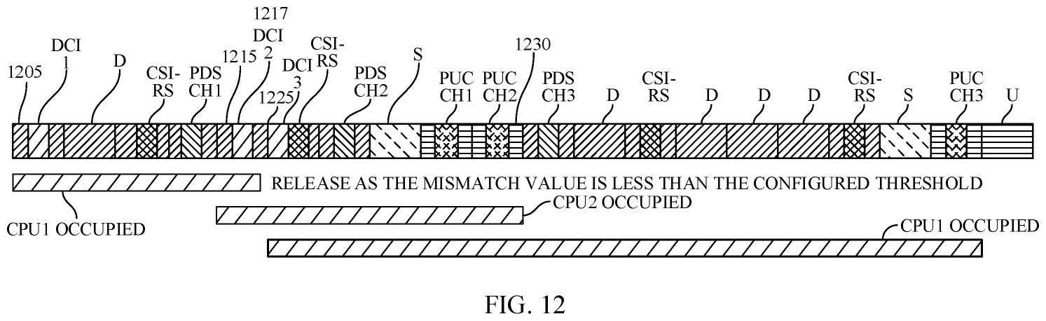

FIG. 12 is an example timeline for CPU occupancy when the CMR type is CSI-RS and when at least one CPU is released for reuse. As shown, assuming that the number of CSI processing units (CPUs) reserved for UE-initiated CSI is 2, i.e., O_{CPU}′=2, CPU1 is initially occupied starting slot 1205 (before DCI1) through slot 1225 (after DCI2); CPU2 has been occupied starting slot 1215 (before DCI2) through slot 1230 (after PUCCH2). If the UE is able to complete the UE-initiated CSI calculation in slot 1217 (corresponding to DCI2 in FIG. 12) and the UE finds that the mismatch value is less than the configured threshold, then the UE releases the CPU1, allowing for UE-initiated CSI based on DCI3 (e.g., and reported on PUCCH3). In other words, because the UE does not need to report UE-initiated CSI in PUCCH1 (due to the mismatch value being below the threshold), the UE is able to calculate the UE-initiated CSI based on DCI3. If the UE finds that the mismatch value is greater than the configured threshold, the UE may report the UE-initiated CSI in PUCCH3. As shown in FIG. 12, the number of occupied CPU reserved for UE-initiated CSI is transparent to the network entity. The network entity may monitor UE-initiated CSI report in the UL resource.

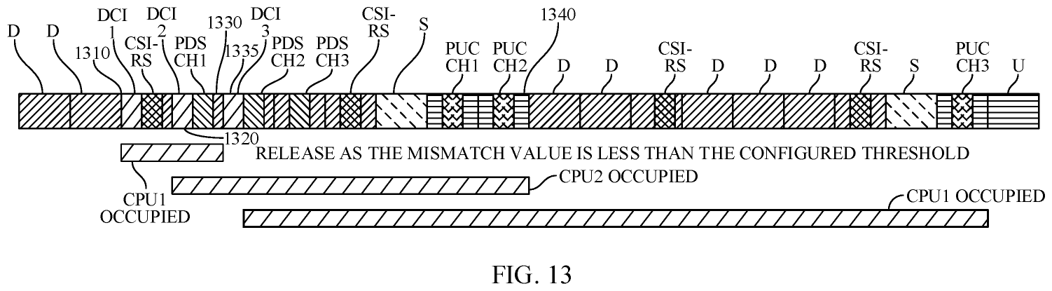

FIG. 13 is an example timeline for CPU occupancy when the CMR type is DMRS or PDSCH and when at least one CPU is released for reuse, in accordance with certain aspects of the present disclosure. Similar to FIG. 12, assuming that the number of CSI processing units (CPUs) reserved for UE-initiated CSI is 2, i.e., O_{CPU}′=2, CPU1 is initially occupied starting DCI1 (slot 1310) through slot 1330; CPU2 has been occupied starting DCI2 (slot 1320) through slot 1340. If the UE is able to complete the UE-initiated CSI calculation prior to DCI3 and the UE finds that the mismatch value is less than the configured threshold, the UE releases the CPU1 to calculate the UE-initiated CSI for DCI3 (starting at slot 1335). This is similar to FIG. 12 except for the CMR type being DMRS or PDSCH. The UE may calculate the UE-initiated CSI for DCI3 and reporting on PUCCH3. If the UE finds that the mismatch value is greater than the configured threshold, the UE may report the UE-initiated CSI in PUCCH3.

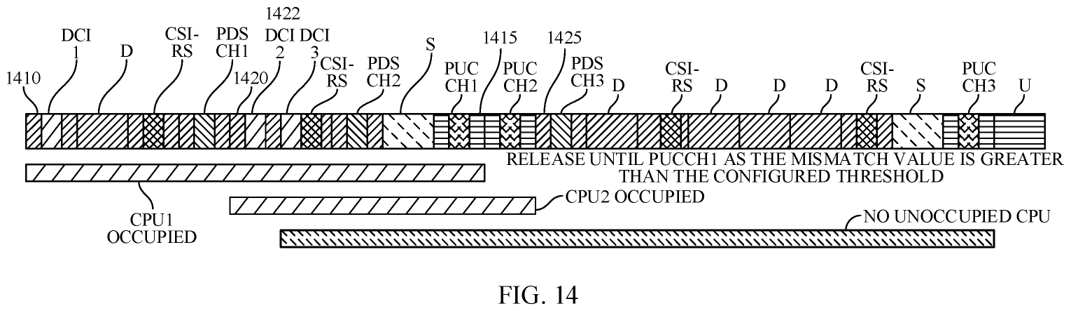

FIG. 14 is an example timeline for CPU occupancy when the CMR type is CSI-RS and when the UE does not release the CPU until physical uplink control channel (PUCCH), in accordance with certain aspects of the present disclosure. As shown, assuming that the number of CSI processing units (CPUs) reserved for UE-initiated CSI is 2, i.e., O_{CPU}′=2, CPU1 is initially occupied starting slot 1410 through slot 1415; CPU2 has been occupied starting slot 1420 through slot 1425. In this example, the UE is able to complete the UE-initiated CSI calculation in slot 1422 (corresponding to DCI2), but finds that the mismatch value is greater than the configured threshold. Therefore, the UE cannot release the CPU to calculate the UE-initiated CSI based on DCI3 and the UE will report the UE-initiated CSI (based on DCI1) in PUCCH1.

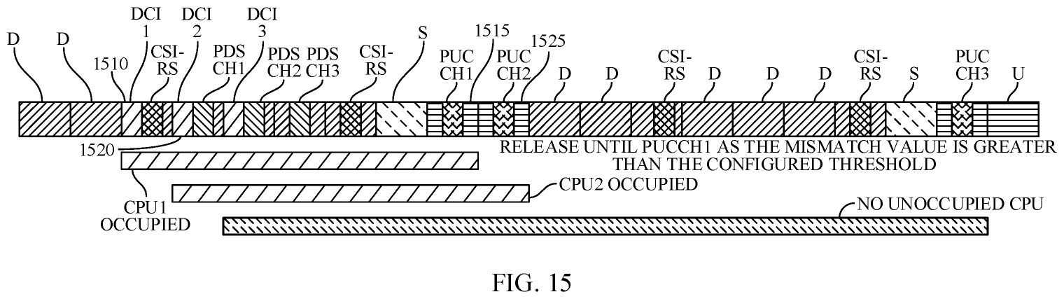

FIG. 15 is an example timeline for CPU occupancy when the CMR type is DMRS or PDSCH and when the UE does not release the CPU until PUCCH in accordance with certain aspects of the present disclosure. As shown, assuming that the number of CSI processing units (CPUs) reserved for UE-initiated CSI is 2, i.e., O_{CPU}=2, CPU1 has been occupied starting DCI1 (slot 1510) through slot 1515; CPU2 has been occupied starting DCI2 (slot 1520) through slot 1525. Because the mismatch value is greater than the configured threshold in this example also, no CPU is available for calculating the UE-initiated CSI for DCI3. As a result, no UE-initiated CSI feedback will be reported in PUCCH3.

In aspects, the UE may release CPUs used in calculating the UE-initiated CSI feedback based on a determined time. For example, the determined time includes a number of symbols (e.g., m symbols) after the UE starts to use the CPUs to calculate UE-initiated CSI feedback. That is, the CPU release condition here is not the last symbol of the configured PUSCH/PUCCH carrying the UE-initiated CSI report. In some cases, the number m is specified or preconfigured, such as in agreed-upon standards. In some cases, the number m may vary based on a capability of the UE. As different UEs may have different capability, the UE may report m in the UE capability report to the network entity.

In aspects, the UE reports to the network entity a maximum number of CPUs for the UE to use for calculating the UE-initiated CSI. The number of CPUs configured by the network entity is less than or equal to the maximum number of CPUs reported by the UE. For example, in some cases, the UE may report a maximum number of CPUs that can be used for UE-initiated CSI, O_{CPU,max}′. In some cases, the UE may report a minimum number of CPUs that may be used for normal CSI calculation, O_{CPU}−O_{CPU,max}′. In some cases, the UE may report to the network entity a minimum number of CPUs for the UE to use for network initiated CSI calculation. The number of CPUs configured by the network entity is greater than or equal to the minimum number of CPUs reported by the UE.

Correspondingly, the network may transmit signaling to the UE configuring or triggering the UE to use one of the CPUs configured for UE-initiated CSI feedback for network initiated CSI feedback. For example, the UE may report the capability O_{CPU}, O_{CPU,max}′ to the network entity. The network entity may configure O_{CPU} CPUs for the UE-initiated CSI feedback. If no CPU is occupied for UE-initiated CSI, the network entity may configure or trigger O_{CPU} CPUs for normal CSI reporting. In addition, the network entity may configure a number of CPUs reserved for UE-initiated CSI, O_{CPU}′. The network entity may configure CMR type, such as the CSI-RS measurement or DMRS/PDSCH measurement. The network entity may also configure whether the UE can early release the CPU if the mismatch value is less than the configured threshold. The network entity may further configure a mismatch threshold value. The network entity may configure a mismatch type configuration.

As noted above, in some cases, the network may update the number of CPUs reserved for UE initiated CSI (O_{CPU}′). For example, in such cases, the UE may be configured with an updated number of CPUs via DCI, MAC-CE, or radio resource control (RRC) signaling.

The updated number of CPUs may be indicated according to various options. According to a first option, the network may reconfigure O_{CPU}′ by signaling the UE directly. According to a second option, the network may pre-configure the UE with a set of candidate values for O_{CPU}′ via RRC signaling. The set of candidate values of O_{CPU}′ may be based on the UE capability report. The network may send a MAC-CE or DCI to activate one of the candidate values from the set.

According to a third option, the network may pre-configure the UE with a set of UE-initiated-CSI-configurations via RRC signaling. Each configuration may indicate a set of parameters (e.g., O_{CPU}′, CMR type, early release threshold value, mismatch threshold value, and/or mismatch type). The set of UE-initiated-CSI-configurations may be based on the UE capability report. The network may send a MAC-CE or DCI to activate one of the UE-initiated-CSI-configuration.

In aspects, the present disclosure supports multiple TRP transmission. In multi-TRP transmissions, the UE-initiated CSI feedback may occupy multiple CPUs. In cases of CSI-RS-based CMR, the number of CPUs may be equal to the number of CSI-RS resources. In some cases, the number of CPUs may be equal to the number of port groups (e.g., each with a particular TCI state). In some cases, the number of CPUs may be equal to the number of CSI hypotheses (e.g., hypo1=trp1, hypo2=trp2, hypo3=trp1+trp2). In cases of DMRS-based CMR, the number of CPUs may be equal to the number of TCI states configured to the DMRS ports.

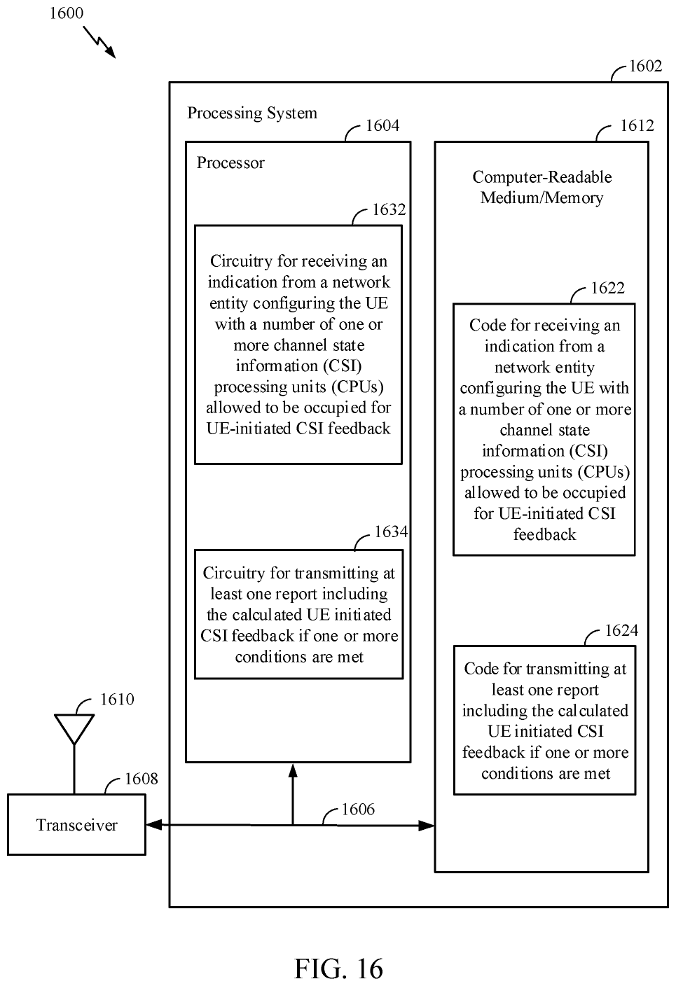

FIG. 16 illustrates a communications device 1600 that may include various components (e.g., corresponding to means-plus-function components) configured to perform operations for the techniques disclosed herein, such as the operations illustrated in FIG. 8. The communications device 1600 includes a processing system 1602 coupled to a transceiver 1608 (e.g., a transmitter and/or a receiver, such as the transceiver (DEMOD) 254 of FIG. 2). The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes a processor 1604 (e.g., the processor or controller 280 of FIG. 2) coupled to a computer-readable medium/memory 1612 via a bus 1606. In certain aspects, the computer-readable medium/memory 1612 is configured to store instructions (e.g., computer-executable code) that when executed by the processor 1604, cause the processor 1604 to perform the operations illustrated in FIG. 8, or other operations for performing the various techniques discussed herein for allocating CPUs. In certain aspects, computer-readable medium/memory 1612 stores code 1622 for receiving an indication from a network entity configuring the UE with a number of one or more channel state information (CSI) processing units (CPUs) allowed to be occupied for UE-initiated CSI feedback, and code 1624 for transmitting at least one report including the calculated UE initiated CSI feedback if one or more conditions are met. In certain aspects, the processor 1604 has circuitry configured to implement the code stored in the computer-readable medium/memory 1612. The processor 1604 includes circuitry 1622 for receiving a CSI report configuration; circuitry 1632 for receiving an indication from a network entity configuring the UE with a number of one or more CPUs allowed to be occupied for UE-initiated CSI feedback, and circuitry 1634 for transmitting at least one report including the calculated UE initiated CSI feedback if one or more conditions are met.

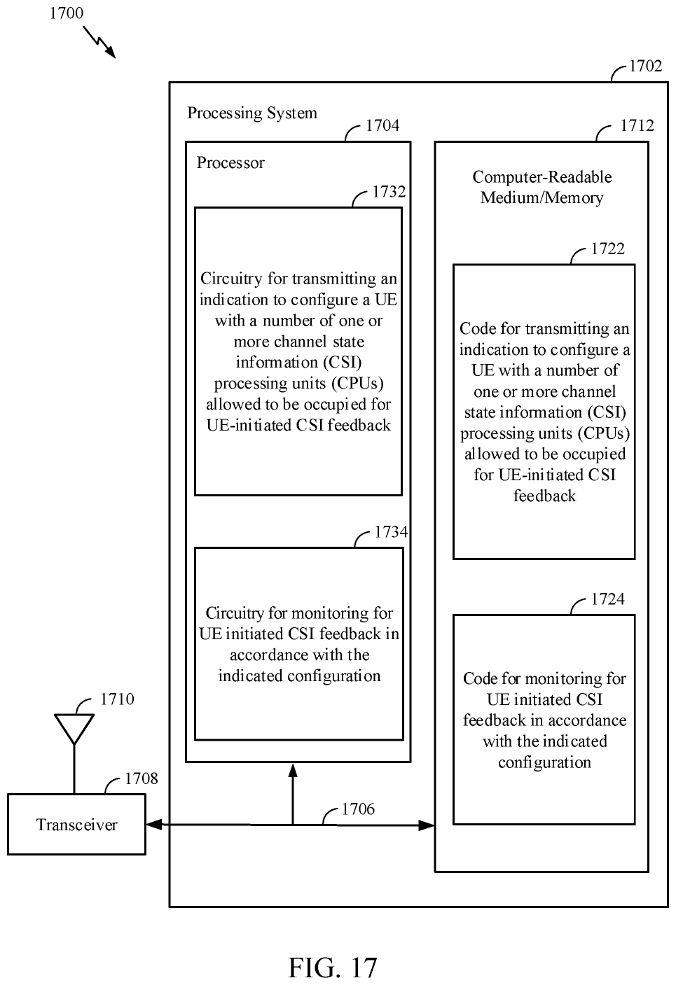

FIG. 17 illustrates a communications device 1700 that may include various components (e.g., corresponding to means-plus-function components) configured to perform operations for the techniques disclosed herein, such as the operations illustrated in FIG. 9. The communications device 1700 includes a processing system 1702 coupled to a transceiver 1708 (e.g., a transmitter and/or a receiver, such as the transceiver (MOD) 232 of FIG. 2). The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes a processor 1704 (e.g., the processor or controller 240 of FIG. 2) coupled to a computer-readable medium/memory 1712 via a bus 1706. In certain aspects, the computer-readable medium/memory 1712 is configured to store instructions (e.g., computer-executable code) that when executed by the processor 1704, cause the processor 1704 to perform the operations illustrated in FIG. 9, or other operations for performing the various techniques discussed herein for allocating CPUs. In certain aspects, computer-readable medium/memory 1712 stores code 1722 for transmitting an indication to configure a user equipment (UE) with a number of one or more channel state information (CSI) processing units (CPUs) allowed to be occupied for UE-initiated CSI feedback, and/or code 1724 for monitoring for UE initiated CSI feedback in accordance with the indicated configuration. In certain aspects, the processor 1704 has circuitry configured to implement the code stored in the computer-readable medium/memory 1712. The processor 1704 includes circuitry 1722 for receiving a CSI report configuration; circuitry 1732 for transmitting an indication to configure a user equipment (UE) with a number of one or more channel state information (CSI) processing units (CPUs) allowed to be occupied for UE-initiated CSI feedback, and/or circuitry 1734 for monitoring for UE initiated CSI feedback in accordance with the indicated configuration.

### Example Aspects

Aspect 1: A method for wireless communications by a user equipment (UE), comprising: receiving, by the UE, an indication from a network entity configuring the UE with a number of one or more channel state information (CSI) processing units (CPUs) allowed to be occupied for UE-initiated CSI feedback; and transmitting, by the UE, at least one report including the UE-initiated CSI feedback if one or more conditions are met.

Aspect 2: The method of Aspect 1, wherein the UE-initiated CSI feedback is based on at least one of CSI reference signals (CSI-RS) or demodulation reference signals (DMRS), and the method further comprising receiving signaling from the network entity indicating whether the UE-initiated CSI feedback is to be based on CSI-RS, DMRS, or both.

Aspect 3: The method of Aspect 1, further comprising using at least one of the CPUs to calculate UE-initiated CSI feedback; and releasing the at least one CPU after a last symbol of a physical uplink shared channel (PUSCH) or physical uplink control channel (PUCCH) carrying the UE-initiated CSI feedback.

Aspect 4: The method of Aspect 1, wherein at least one of the one or more conditions comprises a mismatch being equal to or exceeding a threshold value, wherein the mismatch is between a CSI metric for a scheduled physical downlink shared channel (PDSCH) and a CSI metric calculated as part of the UE-initiated CSI feedback.

Aspect 5: The method of any one of the Aspects 1-4, further comprising using at least one of the CPUs to calculate UE-initiated CSI feedback; and releasing the at least one CPU without reporting the calculated UE-initiated CSI feedback if the mismatch is less than the threshold value.

Aspect 6: The method of Aspect 5, further comprising receiving signaling from the network entity indicating the UE can release CPUs used in calculating the UE-initiated CSI feedback if the mismatch is less than the threshold value.

Aspect 7: The method of Aspect 5, further comprising receiving signaling from the network entity indicating at least one of: the threshold value or a type of CSI metric.

Aspect 8: The method of any one of the Aspects 1-4, wherein the CSI metric for the scheduled PDSCH comprises at least one a modulation and coding scheme (MCS) or rank.

Aspect 9: The method of Aspect 1, further comprising using at least one of the CPUs to calculate UE-initiated CSI feedback; and releasing the at least one CPU based on a determined time.

Aspect 10: The method of Aspect 9, wherein the determined time comprises a number of symbols after the UE starts to use the CPUs to calculate UE-initiated CSI feedback.

Aspect 11: The method of any one of the Aspects 1-10, further comprising receiving signaling configuring the UE with an updated number of one or more CPUs allowed to be occupied for UE-initiated CSI feedback.

Aspect 12: The method of Aspect 11, wherein the signaling comprises at least one of: a downlink control information (DCI) message, a medium access control (MAC) control element (MAC-CE), or radio resource control (RRC) signaling.

Aspect 13: The method of Aspect 10, wherein the number of symbols is specified or preconfigured, or the number of symbols varies based on a capability of the UE, or both.

Aspect 14: The method of Aspect 1, further comprising reporting, to the network entity, a maximum number of CPUs for the UE to use for calculating UE-initiated CSI, wherein the number of CPUs configured by the network entity is less than or equal to the maximum number of CPUs reported by the UE.

Aspect 15: The method of Aspect 14, further comprising reporting to the network entity a minimum number of CPUs for the UE to use for network initiated CSI calculation, wherein the number of CPUs configured by the network entity is greater than or equal to the minimum number of CPUs reported by the UE.

Aspect 16: The method of Aspect 14, further comprising receiving signaling from the network entity configuring or triggering the UE to use one of the CPUs configured for UE-initiated CSI feedback for network initiated CSI feedback.

Aspect 17: The method of Aspect 1, wherein the number of one or more CPUs allowed to be occupied is determined based on at least one of: a number of CSI-RS resources, a number of port groups, each port group corresponding to a transmission configuration indicator (TCI) state, a number of CSI hypothesis, or a number of TCI states configured to a number of demodulation reference signal (DMRS) ports.

Aspect 18: A method for wireless communications by a network entity, comprising: transmitting, an indication to configure a user equipment (UE) with a number of one or more channel state information (CSI) processing units (CPUs) allowed to be occupied for UE-initiated CSI feedback; and monitoring for UE-initiated CSI feedback in accordance with the indicated configuration.

Aspect 19: The method of Aspect 18, wherein the UE-initiated CSI feedback is based on at least one of CSI reference signals (CSI-RS) or demodulation reference signals (DMRS).

Aspect 20: The method of Aspect 18 or 19, further comprising transmitting signaling to the UE indicating whether the UE-initiated CSI feedback is to be based on CSI-RS, DMRS, or both.

Aspect 21: The method of Aspect 18, further comprising receiving at least one UE-initiated CSI feedback and determining that one or more conditions are met upon receiving the at least one UE-initiated CSI feedback, wherein at least one of the one or more conditions comprises a mismatch between a CSI metric for a scheduled physical downlink shared channel (PDSCH) and a CSI metric calculated as part of the UE-initiated CSI feedback being equal to or exceeding a threshold value.

Aspect 22: The method of any one of the Aspects 18-21, further comprising transmitting signaling to the UE indicating the UE can release CPUs used in calculating the UE-initiated CSI feedback if the mismatch between the CSI metric for the scheduled PDSCH and the CSI metric calculated as part of the UE-initiated CSI feedback is less than the threshold value.

Aspect 23: The method of any one of the Aspects 18-21, wherein the CSI metric for the scheduled PDSCH comprises at least one a modulation and coding scheme (MCS) or rank.

Aspect 24: The method of any one of the Aspects 18-22, further comprising determining that the one or more conditions are not met when not receiving the calculated UE-initiated CSI feedback, if the mismatch between the CSI metric for the scheduled PDSCH and the CSI metric calculated as part of the UE-initiated CSI feedback is less than the threshold value.

Aspect 25: The method of Aspect 21 or 22, further comprising transmitting signaling to the UE indicating at least one of: the threshold value or a type of CSI metric.

Aspect 26: The method of Aspect 18, wherein CPUs used in calculating the UE-initiated CSI feedback are released based on a determined time.

Aspect 27: The method of Aspect 26, wherein the determined time comprises a number of symbols after the UE starts to use the CPUs to calculate UE-initiated CSI feedback.

Aspect 28: The method of any one of the Aspects 18-27, further comprising transmitting signaling configuring the UE with an updated number of one or more CPUs allowed to be occupied for UE-initiated CSI feedback.

Aspect 29: The method of Aspect 28, wherein the signaling comprises at least one of: a downlink control information (DCI) message, a medium access control (MAC) control element (MAC-CE), or radio resource control (RRC) signaling.

Aspect 30: The method of Aspect 27, wherein the number of symbols includes at least one of the following properties: the number of symbols is specified or preconfigured, or the number of symbols varies based on a capability of the UE.

Aspect 31: The method of Aspect 18, further comprising: receiving, from the UE, a maximum number of CPUs for the UE to use for calculating UE-initiated CSI; and configuring the UE with a number of CPUs for the UE to use for calculating UE-initiated CSI that is less than or equal to the maximum number of CPUs reported by the UE.

Aspect 32: The method of Aspect 31, further comprising: receiving, from the UE, a minimum number of CPUs for the UE to use for network initiated CSI calculation; and configuring the UE with a number of CPUs for the UE to use for calculating UE-initiated CSI that is greater than or equal to the minimum number of CPUs reported by the UE.

Aspect 33: The method of Aspect 31, further comprising transmitting signaling to the UE for configuring or triggering the UE to use one of the CPUs configured for UE-initiated CSI feedback for network initiated CSI feedback.

Aspect 34: The method of Aspect 18, wherein the number of one or more CPUs allowed to be occupied is determined based on at least one of: a number of CSI-RS resources, a number of port groups, each port group corresponding to a transmission configuration indicator (TCI) state, a number of CSI hypothesis, or a number of TCI states configured to a number of demodulation reference signal (DMRS) ports.

Aspect 35: A user equipment (UE), comprising a memory; a transceiver; and one or more processors in communication with the memory and configured to: receive, via the transceiver, an indication from a network entity configuring the UE with a number of one or more channel state information (CSI) processing units (CPUs) allowed to be occupied for UE-initiated CSI feedback; and transmit, via the transceiver, at least one report including the UE-initiated CSI feedback if one or more conditions are met.

Aspect 36: The UE of Aspect 35, wherein the UE-initiated CSI feedback is based on at least one of CSI reference signals (CSI-RS) or demodulation reference signals (DMRS), and wherein the one or more processors are further configured to receive, via the transceiver, signaling from the network entity indicating whether the UE-initiated CSI feedback is to be based on CSI-RS, DMRS, or both.

Aspect 37: The UE of Aspect 35 or 36, wherein the one or more processors are further configured to: use at least one of the CPUs to calculate UE-initiated CSI feedback; and release CPUs used in calculating the UE-initiated CSI feedback after a last symbol of a physical uplink shared channel (PUSCH) or physical uplink control channel (PUCCH) carrying the UE-initiated CSI feedback.

Aspect 38: The UE of any one of Aspects 35 to 37, wherein at least one of the one or more conditions comprises a mismatch being equal to or exceeding a threshold value, wherein the mismatch is between a CSI metric for a scheduled physical downlink shared channel (PDSCH) and a CSI metric calculated as part of the UE-initiated CSI feedback.

Aspect 39: The UE of Aspect 38, wherein the one or more processors are further configured to: use at least one of the CPUs to calculate UE-initiated CSI feedback; and release CPUs used in calculating the UE-initiated CSI feedback without reporting the calculated UE-initiated CSI feedback if the mismatch becomes less than the threshold value.

Aspect 40: An apparatus for wireless communication by a user equipment (UE), comprising: means for receiving an indication from a network entity configuring the UE with a number of one or more channel state information (CSI) processing units (CPUs) allowed to be occupied for UE-initiated CSI feedback; and means for transmitting at least one report including the UE-initiated CSI feedback if one or more conditions are met.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 8 and/or FIG. 9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications at a user equipment (UE), comprising:
a memory;
a transceiver; and
one or more processors coupled to the memory and the transceiver, the one or more processors configured to cause the UE to:
receive, via the transceiver, an indication from a network entity configuring the UE with a number of one or more channel state information (CSI) processing units (CPUs) allowed to be occupied for UE-initiated CSI feedback; and
transmit, via the transceiver, at least one report including the UE-initiated CSI feedback if one or more conditions are met.

2. The apparatus of claim 1, wherein:
the UE-initiated CSI feedback is based on at least one of CSI reference signals (CSI-RS) or demodulation reference signals (DMRS); and
the one or more processors are further configured to cause the UE to receive, via the transceiver, signaling from the network entity indicating whether the UE-initiated CSI feedback is to be based on CSI-RS, DMRS, or both.

3. The apparatus of claim 1, wherein the one or more processors are further configured to cause the UE to:
use at least one of the CPUs to calculate UE-initiated CSI feedback; and
release the at least one CPU after a last symbol of a physical uplink shared channel (PUSCH) or physical uplink control channel (PUCCH) carrying the UE-initiated CSI feedback.

4. The apparatus of claim 1, wherein at least one of the one or more conditions comprises a mismatch being equal to or exceeding a threshold value, wherein the mismatch is between a CSI metric for a scheduled physical downlink shared channel (PDSCH) and a CSI metric calculated as part of the UE-initiated CSI feedback.

5. The apparatus of claim 4, wherein the one or more processors are further configured to cause the UE to:
use at least one of the CPUs to calculate UE-initiated CSI feedback; and
release the at least one CPU without reporting the calculated UE-initiated CSI feedback if the mismatch is less than the threshold value.

6. The apparatus of claim 5, wherein the one or more processors are further configured to cause the UE to receive, via the transceiver, signaling from the network entity indicating the UE can release CPUs used in calculating the UE-initiated CSI feedback if the mismatch is less than the threshold value.

7. The apparatus of claim 5, wherein the one or more processors are further configured to cause the UE to receive, via the transceiver, signaling from the network entity indicating at least one of: the threshold value or a type of CSI metric.

8. The apparatus of claim 4, wherein the CSI metric for the scheduled PDSCH comprises at least one a modulation and coding scheme (MCS) or rank.

9. The apparatus of claim 1, wherein the one or more processors are further configured to cause the UE to:
use at least one of the CPUs to calculate UE-initiated CSI feedback; and
release the at least one CPU based on a determined time.

10. The apparatus of claim 9, wherein the determined time comprises a number of symbols after the UE starts to use the CPUs to calculate UE-initiated CSI feedback.

11. The apparatus of claim 10, wherein the number of symbols is specified or preconfigured, or the number of symbols varies based on a capability of the UE, or both.

12. The apparatus of claim 1, wherein the one or more processors are further configured to cause the UE to report, to the network entity, a maximum number of CPUs for the UE to use for calculating UE-initiated CSI, wherein the number of CPUs configured by the network entity is less than or equal to the maximum number of CPUs reported by the UE.

13. The apparatus of claim 12, wherein the one or more processors are further configured to cause the UE to report, to the network entity, a minimum number of CPUs for the UE to use for network initiated CSI calculation, wherein the number of CPUs configured by the network entity is greater than or equal to the minimum number of CPUs reported by the UE.

14. The apparatus of claim 12, wherein the one or more processors are further configured to cause the UE to receive, via the transceiver, signaling from the network entity configuring or triggering the UE to use one of the CPUs configured for UE-initiated CSI feedback for network initiated CSI feedback.

15. The apparatus of claim 1, wherein the number of one or more CPUs allowed to be occupied is determined based on at least one of:
a number of CSI-RS resources,
a number of port groups, each port group corresponding to a transmission configuration indicator (TCI) state,
a number of CSI hypothesis, or
a number of TCI states configured to a number of demodulation reference signal (DMRS) ports.

16. An apparatus for wireless communications at a network entity, comprising:
a memory; and
one or more processors coupled to the memory, the one or more processors configured to cause the network entity to:
transmit an indication to configure a user equipment (UE) with a number of one or more channel state information (CSI) processing units (CPUs) allowed to be occupied for UE-initiated CSI feedback; and
monitor for UE-initiated CSI feedback in accordance with the indicated configuration.

17. The apparatus of claim 16, wherein:
the UE-initiated CSI feedback is based on at least one of CSI reference signals (CSI-RS) or demodulation reference signals (DMRS); and
the one or more processors are further configured to cause the network entity to transmit signaling indicating whether the UE-initiated CSI feedback is to be based on CSI-RS, DMRS, or both.

18. The apparatus of claim 16, wherein the one or more processors are further configured to cause the network entity to:
receive at least one UE-initiated CSI feedback and determine that one or more conditions are met upon receiving the at least one UE-initiated CSI feedback, wherein at least one of the one or more conditions comprises a mismatch between a CSI metric for a scheduled physical downlink shared channel (PDSCH) and a CSI metric calculated as part of the UE-initiated CSI feedback being equal to or exceeding a threshold value;
transmit signaling indicating the UE can release CPUs used in calculating the UE-initiated CSI feedback if the mismatch between the CSI metric for the scheduled PDSCH and the CSI metric calculated as part of the UE-initiated CSI feedback is less than the threshold value;
determine that the one or more conditions are not met when not receiving the calculated UE-initiated CSI feedback, if the mismatch between the CSI metric for the scheduled PDSCH and the CSI metric calculated as part of the UE-initiated CSI feedback is less than the threshold value; and
transmit signaling for the UE indicating at least one of: the threshold value or a type of CSI metric.

19. The apparatus of claim 18, wherein the CSI metric for the scheduled PDSCH comprises at least one a modulation and coding scheme (MCS) or rank.

20. The apparatus of claim 16, wherein CPUs used in calculating the UE-initiated CSI feedback are released based on a determined time comprising a number of symbols after the UE starts to use the CPUs to calculate UE-initiated CSI feedback, wherein the number of symbols includes at least one of the following properties: the number of symbols is specified or preconfigured, or the number of symbols varies based on a capability of the UE.

21. The apparatus of claim 16, wherein the one or more processors are further configured to cause the network entity to:
receive a maximum number of CPUs for the UE to use for calculating UE-initiated CSI;
configure the UE with a number of CPUs for the UE to use for calculating UE-initiated CSI that is less than or equal to the maximum number of CPUs reported by the UE;
receive a minimum number of CPUs for the UE to use for network initiated CSI calculation; and
configure the UE with a number of CPUs for the UE to use for calculating UE-initiated CSI that is greater than or equal to the minimum number of CPUs reported by the UE.

22. The apparatus of claim 21, wherein the one or more processors are further configured to cause the network entity to transmit signaling for configuring or triggering the UE to use one of the CPUs configured for UE-initiated CSI feedback for network initiated CSI feedback.

23. The apparatus of claim 16, wherein the number of one or more CPUs allowed to be occupied is determined based on at least one of:
a number of CSI-RS resources,
a number of port groups, each port group corresponding to a transmission configuration indicator (TCI) state,
a number of CSI hypothesis, or
a number of TCI states configured to a number of demodulation reference signal (DMRS) ports.

24. A method for wireless communications by a user equipment (UE), comprising:
receiving an indication from a network entity configuring the UE with a number of one or more channel state information (CSI) processing units (CPUs) allowed to be occupied for UE-initiated CSI feedback; and
transmitting at least one report including the UE-initiated CSI feedback if one or more conditions are met.

25. The method of claim 24, wherein:
the UE-initiated CSI feedback is based on at least one of CSI reference signals (CSI-RS) or demodulation reference signals (DMRS); and
the method further comprises receiving signaling from the network entity indicating whether the UE-initiated CSI feedback is to be based on CSI-RS, DMRS, or both.

26. The method of claim 24, further comprising:
using at least one of the CPUs to calculate UE-initiated CSI feedback; and
releasing the at least one CPU after a last symbol of a physical uplink shared channel (PUSCH) or physical uplink control channel (PUCCH) carrying the UE-initiated CSI feedback.

27. The method of claim 24, wherein at least one of the one or more conditions comprises a mismatch being equal to or exceeding a threshold value, wherein the mismatch is between a CSI metric for a scheduled physical downlink shared channel (PDSCH) and a CSI metric calculated as part of the UE-initiated CSI feedback.

28. The method of claim 27, further comprising:
using at least one of the CPUs to calculate UE-initiated CSI feedback; and
releasing the at least one CPU without reporting the calculated UE-initiated CSI feedback if the mismatch is less than the threshold value.

29. The method of claim 28, further comprising receiving signaling from the network entity indicating the UE can release CPUs used in calculating the UE-initiated CSI feedback if the mismatch is less than the threshold value.

30. A method for wireless communications by a network entity, comprising:
transmitting an indication to configure a user equipment (UE) with a number of one or more channel state information (CSI) processing units (CPUs) allowed to be occupied for UE-initiated CSI feedback; and
monitoring for UE-initiated CSI feedback in accordance with the indicated configuration.
